(19) United States
(12) Patent Application Publication
(10) Pub. No.: US 2008/0272231 A1
(43) Pub. Date: Nov. 6, 2008

(54) Winged Device

(76) Inventor: Peter Logan Sinclair, London (GB)

Correspondence Address: BROOKS KUSHMAN P.C., 1000 TOWN CENTER, TWENTY-SECOND FLOOR, SOUTHFIELD, MI, 48075, US

(21) Appl. No.: 12/096,504

(22) PCT Filed: Dec. 5, 2006
(86) PCT No.: PCT/GB2006/004536

§ 371 Date: Jun. 6, 2008

(30) Foreign Application Priority Data
Dec. 6, 2005 (GB) 0524888.5

(51) Int. Cl. B64C 33/02

(52) U.S. Cl. 244/72

(57) ABSTRACT

A winged device has an axial support which is mounted for reciprocating rotary motion about a longitudinal axis of the support. A first wing vane is mounted to the axial support for rotation with the axial support. A second wing vane is mounted to the axial support. A cam follower is constrained to a defined movement path by a cam. A first connector connects the first wing vane to the cam follower such that the cam follower is moved along the cam by the first connector as the first wing vane moves with rotation of the axial support about its longitudinal axis. A second connector connects the second wing vane to the cam follower such that the second wing vane is moved by the second connector as the cam follower member is moved along the cam. The cam profile is defined relative to the axis of the axial support such that the relative orientation of the wing vanes changes as the axial support is rotated. The axial support is received by a pivot member within which the axial support can rotate about its longitudinal axis. The pivot member is driven in reciprocating angular motion about a transverse axis which crosses the longitudinal axis of the axial support, so that the axial support oscillates about the transverse axis B.

### FIELD OF THE INVENTION

The present invention relates to a winged device and, in particular to an improved wing movement mechanism for such a device.

### BACKGROUND TO THE INVENTION

In my earlier applications WO 2003/004122 and WO 2004/112929 I have described winged devices that mimic the wing movements of insects and/or hummingbirds. The flying abilities of such animals have significant advantages over, for example fixed wing aircraft or helicopters, because of their increased flexibility of movement in the air.

This application describes wing movement mechanisms that are improvements over my earlier designs in that they provide a more refined movement of the wing and in certain embodiments a simplified mechanical construction.

### SUMMARY OF THE INVENTION

According to an invention described herein, there is provided a winged device comprising:
an axial support mounted for reciprocating rotary motion about a longitudinal axis of the support;
a first wing vane mounted to the axial support for rotation therewith;
a second wing vane mounted to the axial support;
a follower member constrained to a defined movement path by at least one follower guide,
a first connector which connects the first wing vane to the follower member such that the follower member is moved along the movement path by the first connector as the first wing vane moves with rotation of the axial support about its longitudinal axis;
a second connector which connects the second wing vane to the follower member such that the second wing vane is moved by the second connector as the follower member is moved along the movement path;
wherein the movement path of the follower member is defined relative to the axis of the axial support such that the relative orientation of the wing vanes changes as the axial support is rotated.

Thus, according to an invention disclosed herein, the relative orientation of the wing vanes is controlled by the movement path of the follower member in a relatively simple manner as the axial wing support oscillates rotationally. In this way, it is unnecessary for an additional drive mechanism to be provided to adjust the camber of the wing as the wing camber variation is driven by the oscillating movement of the axial support.

The follower guide may be a cam and the follower member may be a cam follower. In one arrangement, the cam is a circular cam mounted eccentrically with respect to the longitudinal axis of the axial support. However, other cam profiles are possible.

Alternatively, the follower guide may be a guide rail received by the follower member. The guide rail may be straight or may have an arcuate profile. More complex shapes of the guide rail are possible. The guide rail may be received in an aperture or slot defined in the follower member.

The follower may be formed integrally with the first or second connector or may be in the form of a separate connected piece. The first and/or second connectors may connect directly indirectly to the wing vanes and/or the follower member. For example, additional intermediate connectors may be provided. In general, the first and/or second connectors are hingedly connected to the wing vanes and/or follower member.

The first connector generally connects to the first wing vane at a point spaced from the axis of the axial support in order to achieve a mechanical advantage to drive the follower member. The second connector may similarly connect to the second wing vane at a point spaced from the axis of the axial support.

To achieve a simple construction, the movement path may be defined in a plane that is substantially perpendicular to the longitudinal axis of the axial support. For example, the cam may be in the form of a disc arranged perpendicularly to the axis of the axial member.

The first and/or second wing vane may be formed of flexible material, such as plastics. The first and/or second wing vane may be fixed to the axial support for rotation therewith. In this way, the rotation of the axial support causes flexing of the wing vanes. The axial support may be formed integrally with the first wing vane.

The second wing vane may be hingedly connected to the axial support. In this way, the rotation of the axial support alters the angle between the first and second wing vanes at the axial support. A combination of flexing and hinging is possible.

The device may comprise a drive member connected to the axial support and arranged to impart the reciprocating rotational movement to the axial support. For example, the drive member may be in the form of a crank. Such a crank may be driven by a rotating cam and cam follower in order to impart reciprocating linear motion to the crank. Alternatively, a linear motor or other similar device may be used

The drive member may be connected to the axial support by an articulated connection such that the angle between the drive shaft and the axial support can be varied. In such an arrangement, the angle between the axial support and the body of the device may be varied. In embodiments of the invention, the articulated connection comprises a universal joint. However, other articulated connections such as a flexible connector or a spring may be used.

The axial support may be received by a pivot member within which the axial support can rotate about its longitudinal axis, for example by means of a collar in the pivot member. The pivot member may be arranged to pivot about a transverse axis which crosses the longitudinal axis of the axial support. The transverse axis may be perpendicular to the longitudinal axis of the axial support. The pivot member may be arranged to be driven in reciprocating angular motion about the transverse axis, whereby the axial support oscillates about the transverse axis. In this way, the winged device is able to move the wings in three movement: variation of the wing camber; axial oscillation about the axis of the axial member; and angular oscillation about the transverse axis. It is believed that such a combination of movements accurately reflects the wing movements of many insects.

The pivot member may be driven by a rotating cam and cam follower in order to impart reciprocating motion to the pivot member. Alternatively, a linear motor or other similar device may be used. The same cam may be used to drive the axial oscillation of the axial support and the angular oscillation of the pivot member. Alternatively, different cams (or linear motors) may be used.

### BRIEF DESCRIPTION OF THE DRAWINGS

Embodiments of the invention will now be described by way of example only and with reference to the accompanying drawings, in which:

FIG. 1 is a perspective view of a wing movement mechanism according to a first embodiment of the invention;

FIG. 2 is a reversed perspective view of the wing movement mechanism of FIG. 1 with some components removed for clarity;

FIG. 3 is an elevation of the rear of the wing movement mechanism of FIG. 1;

FIG. 4 is an elevation of the front of the wing movement mechanism of FIG. 1 viewed along the axis of the wing;

FIG. 5 is a perspective view of a wing movement mechanism according to a second embodiment of the invention;

FIG. 6 is a reversed perspective view of the wing movement mechanism of FIG. 5;

FIG. 7 is an elevation of the rear of the wing movement mechanism of FIG. 5;

FIG. 8 is a perspective view of a wing movement mechanism according to a third embodiment of the invention;

FIG. 9 is an enlarged perspective view of the interior of the wing movement mechanism of FIG. 8 with some components removed for clarity;

FIG. 10 is an enlarged perspective view of part of the wing movement mechanism of FIG. 8;

FIG. 11 is a perspective view of a wing movement mechanism according to a fourth embodiment of the invention;

FIG. 12 is a reverse perspective view of the wing movement mechanism of FIG. 11;

FIG. 13 is a perspective view of part of the wing movement mechanism of FIG. 11 with some parts removed for clarity;

FIG. 14 is a perspective view of part of the wing movement mechanism of FIG. 11 with some parts removed for clarity;

FIG. 15 is a plan view of a wing movement mechanism according to a fifth embodiment of the invention;

FIG. 16 is a perspective view of part of the wing movement mechanism of FIG. 15;

FIG. 17 is a perspective view of part of the wing movement mechanism of FIG. 15; and

FIG. 18 is a perspective view of a wing movement mechanism according to a sixth embodiment of the invention.

### DETAILED DESCRIPTION OF EMBODIMENTS OF THE INVENTION

In the detailed description of the embodiments of the invention, the same reference numerals are used to designate corresponding components of the embodiments.

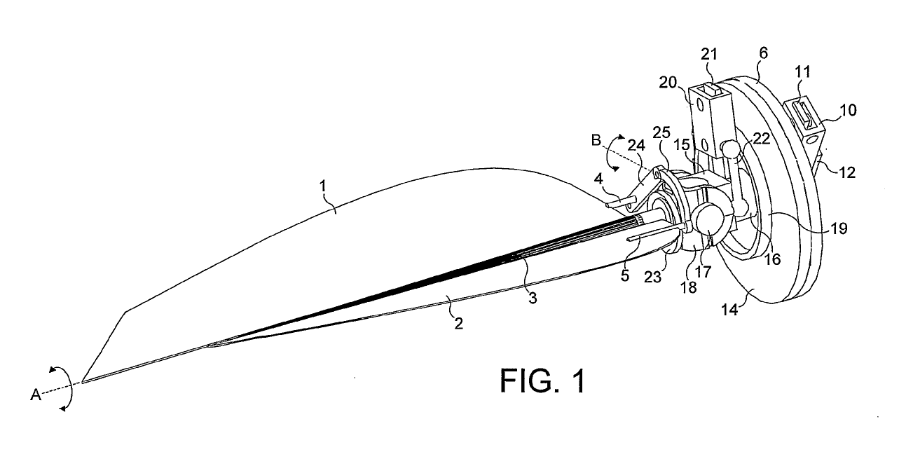

FIG. 1 shows a wing movement mechanism according to a first embodiment of the invention. The wing comprise a first vane 1 and a second vane 2 mounted to an axial support 3. Each vane 1, 2 is further connected to the wing movement mechanism by respective first and second vane rods 4, 5. In this embodiment, the first vane 1 provides the trailing edge of the wing and the second vane 2 provides the leading edge of the wing. As will be explained in detail below, the wing movement mechanism is configured to move the wing in three independent movements.

The first movement is rotation of the axial support 3 (and hence the vanes 1, 2) about its longitudinal axis (A in FIG. 1). In this embodiment, the wing movement mechanism is configured for reciprocating rotation of the axial support 3 about its longitudinal axis A, with a range of movement of up to approximately 180 degrees.

The second movement is tilting of the axial support 3 about a transverse axis (B in FIG. 1), which is perpendicular to the longitudinal axis A of the axial support 3. Again, in this embodiment, the wing movement mechanism is configured for reciprocating tilting of the axial support 3 about the transverse axis B, with a range of movement of up to approximately 120 degrees (60 degrees left or right of centre).

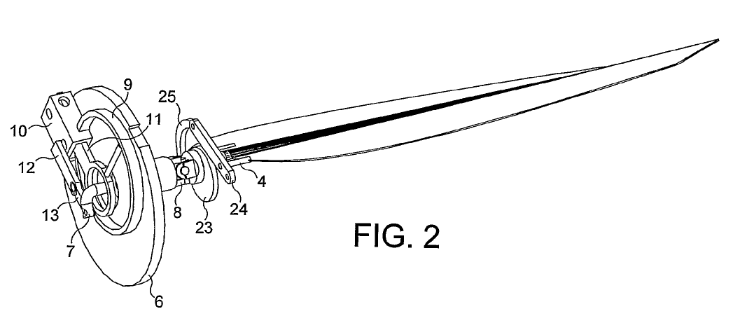

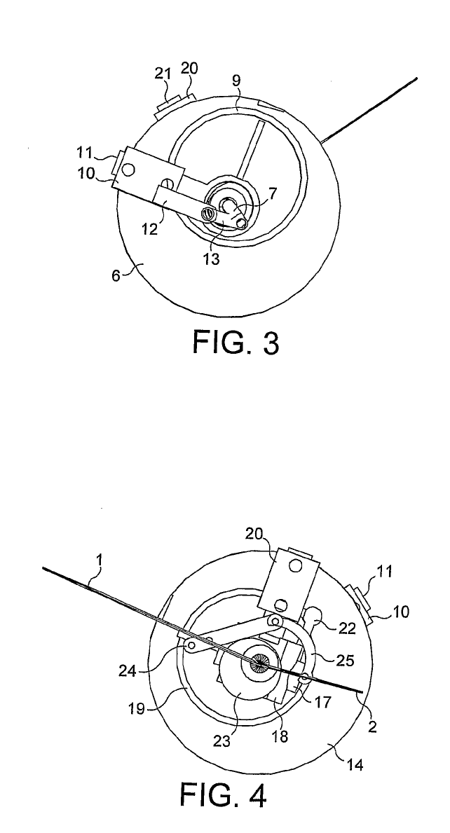

The third movement is flexure of the vanes 1, 2 by movement of the vane rods 4, 5 relative the axial support 3. In this embodiment, the degree of flexure of the vanes 1, 2 is determined by the rotational position of the axial support 3 about its longitudinal axis A. Referring now to FIGS. 2 and 3, the components of the wing movement mechanism which generate the first movement (rotation of the axial support 3 about its longitudinal axis A) will be described in detail. It should be noted that in FIG. 2, the components of the wing movement mechanism which generate the second movement (tilting of the axial support 3 about a transverse axis B) have been removed for clarity. The first movement mechanism comprises a first drive disc 6 which is driven by an electric motor (not shown) to rotate about its centre. At the centre of the first drive disc 6, a crank arm 7 is mounted for rotation within an aperture in the first drive disc 6. The crank arm 7 passes through the drive disc 6 and is fixedly connected to a universal joint 8. The side of the universal joint 8 remote from the crank arm 7 is fixedly connected to the axial support 3 of the wing. Thus rotation of the crank arm 7 about its axis normal to the plane of the first drive disc 6 causes corresponding rotation of the universal joint 8 and hence rotation of the axial support 3 about its longitudinal axis A.

A first circular cam track 9 is positioned on the surface of the first drive disc 6 eccentrically with respect to the drive disc 6. A first cam follower 10 engages the first cam track 9 and is constrained to linear reciprocal motion by a first cam follower guide 11 slidably received by the first cam follower 10. The first cam follower guide 11 is rotatably mounted at its end remote from the first cam follower 10 to the drive disc 6, so that the drive disc 6 can rotate with respect to the first cam follower guide 11 and the first cam follower 10. The first cam follower 10 comprises a first cam arm 12 fixedly connected thereto. A crank connector 13 is hingedly connected to each of the first cam arm 12 and the crank arm 7, such that reciprocal motion of the first cam follower 10 results in rotation of the crank arm 7 about its axis normal to the plane of the first drive disc 6.

It will be seen that continuous rotation of the first drive disc 6 cause the first cam track 9 to drive the first cam follower 10 along a reciprocal path, such that the crank arm 7 and hence the axial support 3 are rotated reciprocally about their axes. The exact movement of the axial support 3 about its longitudinal axis A can be determined by the configuration, i.e. shape, size and position, of the first cam track 9.

Referring now to FIGS. 1 and 4, the components of the wing movement mechanism which generate the second movement (tilting of the axial support 3 about a transverse axis B) will be described in detail. The second movement mechanism comprises a second drive disc 14 mounted in facing relation and concentrically with the first drive disc 6 for rotation therewith. It should be noted that the second drive disc 14 may be driven by a second electric motor (not shown) independently of the rate of rotation of the first drive disc 6, if desired. However, in this embodiment, the first and second drive disc 6, 14 are fixed together in operation.

The second movement mechanism further comprises a first pivot member 15 having a cylindrical collar 16 located around the cylindrical part of the universal joint 8 that connects to the crank arm 7 and mounted for rotation within an aperture in the second drive disc 14. In this way, the crank arm 7 and universal joint 8 can rotate with respect to the first pivot member 15, as can the second drive disc 14. The first pivot member 15 extends from the collar 16 as a C-section yolk within which the hinged parts of the universal joint 8 are received. Projecting from each outside face of the C-section yolk is a respective cylindrical bar section 17 arranged with its axis aligned with the transverse axis B. A second pivot member 18 is generally U-shaped and has an aperture defined in each of its limbs to receive the bar sections 17 of the first pivot member 15, such that the second pivot member 18 can pivot with respect to the first pivot member 15 about the transverse axis B. Between its limbs, the second pivot member 18 has an aperture defined therein for receiving the end of the universal joint 8 attached to the axial support 3, such that the universal joint 8 can rotate within this aperture about the longitudinal axis A. Thus, tilting of the second pivot member 18 about the transverse axis B causes tilting of the axial support 3 about the same axis.

A second circular cam track 19 is positioned on the surface of the second drive disc 14 eccentrically with respect to the drive disc 14. A second cam follower 20 engages the second cam track 19 and is constrained to linear reciprocal motion by a second cam follower guide 21 slidably received by the second cam follower 20. The second cam follower guide 21 is formed integrally with the collar 17 of the first pivot member 15, so that the second drive disc 14 can rotate with respect to the second cam follower guide 21 and the second cam follower 20. A second cam arm 22 is hingedly connected between the second cam follower 20 and the second pivot member 18, such that reciprocal motion of the second cam follower 20 results in tilting of the second pivot member 18 about the transverse axis B and consequent tilting of the axial support 3 about the same axis.

It will be seen that continuous rotation of the second drive disc 14 causes the second cam track 19 to drive the second cam follower 20 along a reciprocal path, such that the second pivot member 18 and hence the axial support 3 are tilted reciprocally about the transverse axis B through the bar sections 17. The exact movement of the axial support 3 about the transverse axis B can be determined by the configuration, i.e. shape, size and position, of the second cam track 19.

Referring now to FIGS. 1, 2 and 4, the components of the wing movement mechanism which generate the third movement (flexure of the vanes 1, 2) will be described in detail. The third movement mechanism comprises a circular cam member 23 mounted eccentrically about the end of the universal joint 8 attached to the axial support 3. The circular cam member 23 is fixedly mounted to the second pivot member 18 so that the axial support 3 can rotate about its axis A relative to the circular cam member 23. A third cam follower 24 engages the surface of the cam member 23 and is attached at one end to the first vane rod 4. In this embodiment, the first vane 1 of the wing is fixedly mounted to the axial support for rotation therewith about the axis A. Thus, as the universal joint 8 and axial support 3 rotate, the third cam follower 24 moves across the cam surface of the cam member 23 and the third cam follower 24 is deflected by the cam member 23 to flex the first vane 1 of the wing.

At its end remote from the first vane rod 4 the third cam follower 24 is hingedly connected to the end of a vane arm 25 which is connected at its other end to the second vane rod 5. In this embodiment, the second vane 2 is hingedly connected to the axial support 3, such that, as the universal joint 8 and axial support 3 rotate, the deflection of the third cam follower 24 moves the vane arm 25 to flex the second vane 2 of the wing. The exact movement of the vane rods 4, 5 with rotation of the axial support 3 can be determined by the configuration, i.e. shape, size and position, of the cam member 23, the distance of the first vane rod 4 from the axis A of the axial support 3, the length of the third cam follower 24 and the length of the vane arm 25.

In an alternative embodiment, the second vane 2 of the wing may be fixedly mounted to the axial support for rotation therewith about the axis A and the first vane 1 may be hingedly connected to the axial support 3.

It will appreciated from the foregoing that the three movements of the wing are each determined independently by the configuration of the first cam track 9, the second cam track 19 and the cam member 23, respectively. Thus, in accordance with the invention, each movement can be tuned independently of the others to provide the required movement of the wing for effective flight.

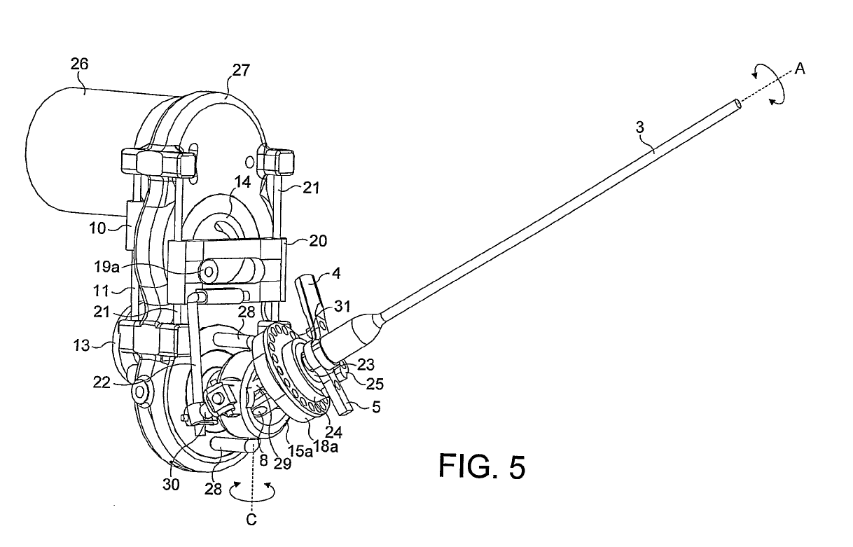

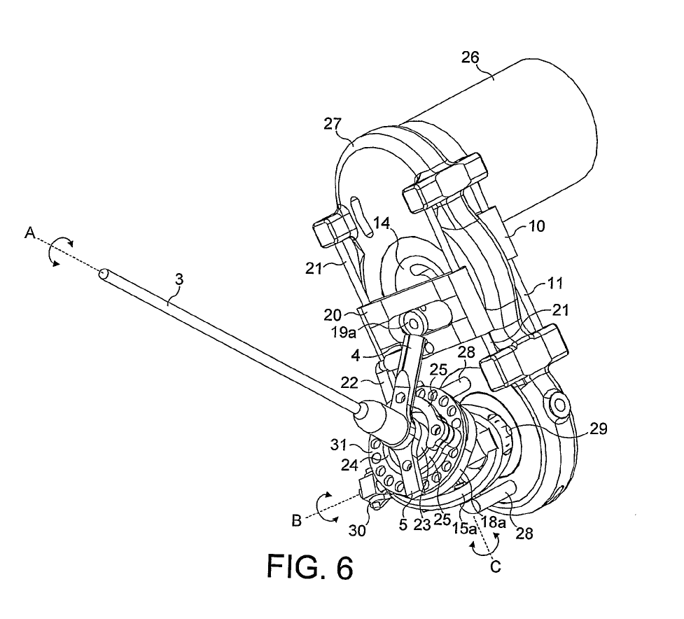

FIG. 5 shows a wing movement mechanism according to a second embodiment of the invention. As with the embodiment of FIG. 1, the wing comprises a first vane 1 and a second vane 2 mounted to an axial support 3. However, in FIGS. 5 to 6, the vanes 1, 2 are not shown. As will be explained in detail below, the wing movement mechanism is configured to move the wing in three independent movements, like that of the first embodiment.

The first movement is rotation of the axial support 3 (and hence the vanes 1, 2) about its longitudinal axis (A in FIGS. 5 to 7). In this embodiment, the wing movement mechanism is configured for reciprocating rotation of the axial support 3 about its longitudinal axis A, with a range of movement of up to approximately 180 degrees.

The second movement is tilting of the axial support 3 about a transverse axis (B in FIG. 6), which is perpendicular to the longitudinal axis A of the axial support 3. Again, in this embodiment, the wing movement mechanism is configured for reciprocating tilting of the axial support 3 about the transverse axis B, with a range of movement of up to approximately 120 degrees (60 degrees left or right of centre).

The third movement is flexure of the vanes 1, 2 by movement of the vane rods 4, 5 relative to the axial support 3. In this embodiment, the degree of flexure of the vanes 1, 2 is determined by the rotational position of the axial support 3 about its longitudinal axis A.

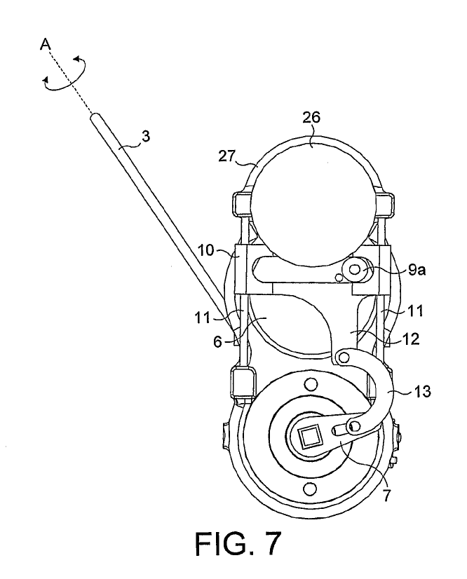

Referring now to FIG. 7, the components of the wing movement mechanism which generate the first movement (rotation of the axial support 3 about its longitudinal axis A) will be described in detail. The first movement mechanism comprises a first drive disc 6 which is driven by an electric motor 26 to rotate about its centre. The first drive disc 6 is mounted in a chassis 27 to which the electric motor 26 is also mounted.

A first cam member 9a is positioned on the surface of the first drive disc 6 such that it describes a circular path as the first drive disc 6 rotates. A first cam follower 10 receives the first cam member 9a in a slot defined in the first cam follower 10. The first cam follower 10 is constrained to linear reciprocal motion by first cam follower guides 11 slidably received by the first cam follower 10 and mounted to the chassis 27. The first cam follower guides 11 run in parallel in a direction perpendicular to that of the slot in the first drive disc 6. In this way, as the first drive disc 6 rotates, the first cam member 9a reciprocates transversely in the slot in the first cam follower 10 and the first cam follower 10 is driven backwards and forwards along the first cam follower guides 11.

The first cam follower 10 comprises a first cam arm 12 integrally formed therewith. A crank connector 13 is hingedly connected to each of the first cam arm 12 and a crank arm 7, which is mounted for rotation in an aperture in the chassis 27. The crank arm 7 passes through the chassis 27 and is fixedly connected to a universal joint 8 (see FIG. 5). The side of the universal joint 8 remote from the crank arm 7 is fixedly connected to the axial support 3 of the wing. Thus rotation of the crank arm 7 about its axis normal to the plane of the chassis 27 causes corresponding rotation of the universal joint 8 and hence rotation of the axial support 3 about its longitudinal axis A.

It will be seen that continuous rotation of the first drive disc 6 cause the first cam member 9a to drive the first cam follower 10 along a reciprocal path, such that the crank arm 7 and hence the axial support 3 are rotated reciprocally about their axes. The exact movement of the axial support 3 about its longitudinal axis A can be determined by the position of the first cam member 9a on the first drive disc 6, the size of the first cam arm 12 and the size of the crank connector 13.

Referring now to FIG. 5, the components of the wing movement mechanism which generate the second movement (tilting of the axial support 3 about a transverse axis B) will be described in detail. The second movement mechanism comprises a second drive disc 14 mounted in facing relation and concentrically with the first drive disc 6 for rotation therewith. It should be noted that the second drive disc 14 may be driven by a second electric motor (not shown) independently of the rate of rotation of the first drive disc 6, if desired. However, in this embodiment, the first and second drive disc 6, 14 are driven together in operation.

A second cam member 19a is positioned on the surface of the second drive disc 14 such that it describes a circular path as the second drive disc 14 rotates. A second cam follower 20 receives the second cam member 19a in a slot defined in the second cam follower 20. The second cam follower 20 is constrained to linear reciprocal motion by second cam follower guides 21 slidably received by the second cam follower 20 and mounted to the chassis 27. The second cam follower guides 21 run in parallel in a direction perpendicular to that of the slot in the second drive disc 14. In this way, as the second drive disc 14 rotates, the second cam member 19a reciprocates transversely in the slot in the second cam follower 20 and the second cam follower 20 is driven backwards and forwards along the second cam follower guides 21.

The second movement mechanism further comprises a first pivot ring 15a, which is pivotally mounted to the chassis 27 on supports 28. The pivot ring 15a is able to pivot on the supports about an axis (C in FIGS. 5 and 6) perpendicular to the axis B. The axis C passes through the articulation point of the universal joint 8. A second pivot ring 18a is mounted about the axis A and is connected to the first pivot ring 15a by two L-shaped rods 29, each having a first limb fixedly connected to the second pivot ring 18a and aligned parallel to the axis A and a second limb mounted for rotation in a journal in the first pivot ring 15a and aligned with the axis B. The second pivot ring 18a defines an aperture in which the end of the universal joint 8 attached to the axial support 3 is received, such that the universal joint 8 can rotate within this aperture about the longitudinal axis A (a bearing ring is provided between the surfaces of the universal joint 8 and the second pivot ring 18a to aid smooth rotation). Thus, the second pivot ring 18a can tilt about the transverse axis B relative to the first pivot ring 15a causing tilting of the axial support 3 about the same axis. In addition, the first pivot ring 15a can tilt about the axis C relative to the chassis 27 causing tilting of the axial support 3 about the same axis. This latter movement can be used to control banking of the wing without a bulk movement of the whole device.

One of the L-shaped rods 29 connecting the first and second pivot rings 15a, 18a rotates freely in the journal in the first pivot ring 15a and provides balancing support for the second pivot ring 18a. The other L-shaped rod is connected at the outside of the first pivot ring 15a via a universal connection 30 to a second cam arm 22 which is hingedly connected to the second cam follower 20. It will be seen that continuous rotation of the second drive disc 14 causes the second cam member 19a to drive the second cam follower 20 along a reciprocal path, such that the second pivot member 18a and hence the axial support 3 are tilted reciprocally about the transverse axis B. The exact movement of the axial support 3 about the transverse axis B can be determined by the position, of the second cam member 19a on the second drive disc 14.

Referring now to FIGS. 1, 2 and 4, the components of the wing movement mechanism which generate the third movement (flexure of the vanes 1, 2) will be described in detail. The third movement mechanism comprises a circular cam member 23 mounted eccentrically about the end of the universal joint 8 attached to the axial support 3. The circular cam member 23 is fixedly mounted to the second pivot member 18 so that the axial support 3 can rotate about its axis A relative to the circular cam member 23. A third cam follower 24 engages the surface of the cam member 23 and is attached at one end to the first vane rod 4. In this embodiment, the first vane 1 of the wing is fixedly mounted to the axial support for rotation therewith about the axis A. Thus, as the universal joint 8 and axial support 3 rotate, the third cam follower 24 moves across the cam surface of the cam member 23 and the third cam follower 24 is deflected by the cam member 23 to flex the first vane 1 of the wing.

At its end remote from the first vane rod 4 the third cam follower 24 is hingedly connected to the end of a vane arm 25 which is connected at its other end to the second vane rod 5. In this embodiment, the second vane 2 is hingedly connected to the axial support 3, such that, as the universal joint 8 and axial support 3 rotate, the deflection of the third cam follower 24 moves the vane arm 25 to flex the second vane 2 of the wing. The exact movement of the vane rods 4, 5 with rotation of the axial support 3 can be determined by the configuration, i.e. shape, size and position, of the cam member 23, the distance of the first vane rod 4 from the axis A of the axial support 3, the length of the third cam follower 24 and the length of the vane arm 25.

In an alternative embodiment, the second vane 2 of the wing may be fixedly mounted to the axial support for rotation therewith about the axis A and the first vane 1 may be hingedly connected to the axial support 3.

It will appreciated from the foregoing that the three movements of the wing are each determined independently by the configuration of the first cam track 9, the second cam track 19 and the cam member 23, respectively. Thus, in accordance with the invention, each movement can be tuned independently of the others to provide the required movement of the wing for effective flight.

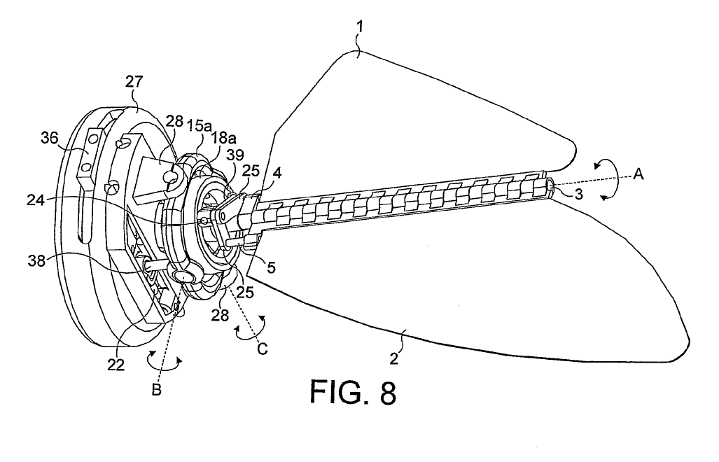

FIGS. 8 to 10 show a wing movement mechanism according to a third embodiment of the invention. The wing comprises a first vane 1 and a second vane 2 mounted to an axial support 3. Each vane 1, 2 is further connected to the wing movement mechanism by respective first and second vane rods 4, 5. In this embodiment, the first vane 1 provides the trailing edge of the wing and the second vane 2 provides the leading edge of the wing.

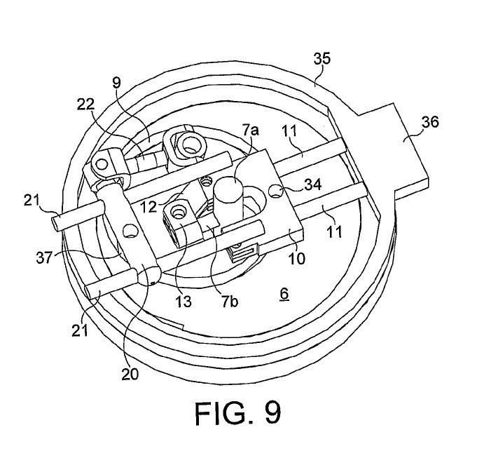

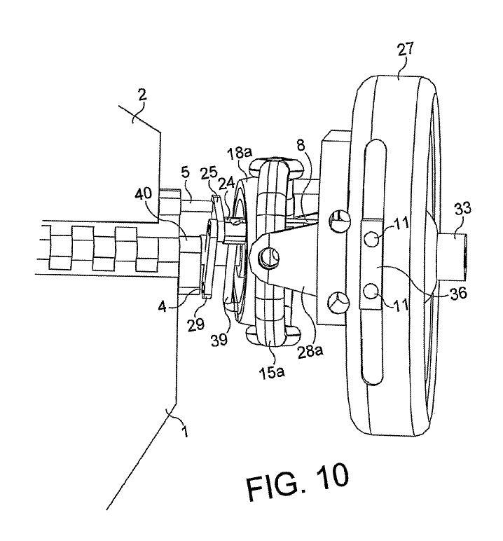

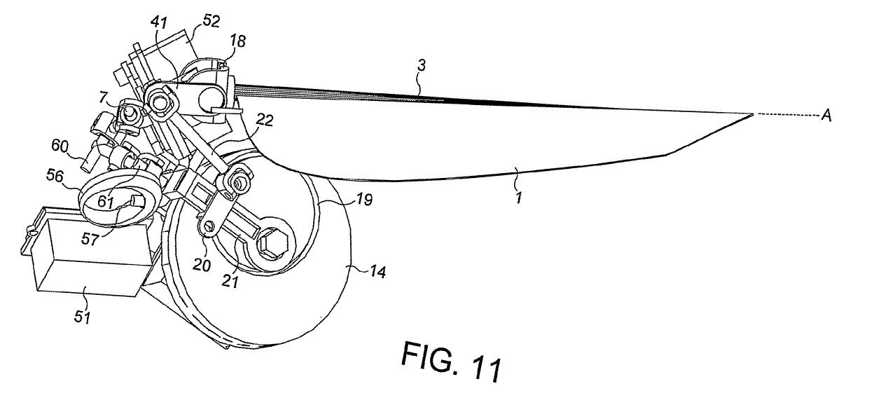

Referring now to FIG. 9, the components of the wing movement mechanism which generate the first movement (rotation of the axial support 3 about its longitudinal axis A) will be described in detail. The components of the first movement mechanism are housed in a chassis 27, which has been removed in FIG. 9 to reveal the internal components of the mechanism. The first movement mechanism comprises a first drive disc 6 which is driven by an electric motor (not shown) to rotate about its centre. The electric motor engages with a drive connector 33 which extends from the rear of the drive disc (see FIG. 10) and is fixedly connected to the first drive disc 6. At the centre of the first drive disc 6, a crank shaft 7a is mounted for rotation within an aperture in the first drive disc 6. A crank pin 7b is fixed to the crank shaft 7a and is perpendicular to the longitudinal axis of the drive shaft 7a. Together, the crank shaft 7a and crank pin 7b form a crank 7. At its end remote from the surface of the drive disc 6, the crank shaft 7a is fixedly connected to a universal joint 8 (omitted in FIG. 9 for clarity). The side of the universal joint 8 remote from the crank shaft 7a is fixedly connected to the axial support 3 of the wing. Thus rotation of the crank shaft 7a about its axis normal to the plane of the first drive disc 6 causes corresponding rotation of the universal joint 8 and hence rotation of the axial support 3 about its longitudinal axis A.

A first circular cam track 9 is defined as a groove in the surface of the first drive disc 6 eccentrically with respect to the drive disc 6. A first cam follower 10 engages the first cam track 9 by means of a first cam pin 34 which extends from the first cam follower 10 into the groove of the first cam track 9. The first cam follower 10 is constrained to linear reciprocal motion by first cam follower guides 11 slidably received by the first cam follower 10. The first cam follower guides 11 are mounted to an axial adjustment ring 35 which can be rotated about its centre relative to the chassis 27. The axial adjustment ring 35 is provided with an adjustment tab 36 which projects through a slot defined in the chassis 27 in order to allow the user to rotate the axial adjustment ring 35 relative to the chassis 27. Rotation of the axial adjustment ring 35 adjusts the direction of the first cam follower guides 11 and thus the direction of the reciprocating movement of the first cam follower 10 with a range of about 60 degrees in each direction. As will be apparent from the following, this adjustment rotates the arc described by the reciprocating axial motion of the axial support 3.

The first cam follower 10 comprises a first cam arm 12 fixedly connected thereto. A crank connector 13 is hingedly connected to each of the first cam arm 12 and the crank pin 7b, such that reciprocal linear motion of the first cam follower 10 results in rotation of the crank shaft 7a about its axis normal to the plane of the first drive disc 6. It will be seen that continuous rotation of the first drive disc 6 cause the first cam track 9 to drive the first cam follower 10 along a reciprocal path, such that the crank shaft 7a and hence the axial support 3 are rotated reciprocally about their axes. The exact movement of the axial support 3 about its longitudinal axis A can be determined by the configuration, i.e. shape, size and position, of the first cam track 9.

Referring now to FIGS. 8 and 9, the components of the wing movement mechanism which generate the second movement (tilting of the axial support 3 about a transverse axis B) in this third embodiment will be described in detail. In this is embodiment, there is no second drive disc as in previous embodiments. The role of the second drive disc is provided in this embodiment by the first drive disc 6. Thus, a second cam follower 20 engages the first cam track 9 by means of a second cam pin 37 which projects from the second cam follower 20 into the groove of the first cam track 9. The second cam follower 20 is constrained to linear reciprocal motion by second cam follower guides 21 slidably received by the second cam follower 20. The second cam follower guides 21 are mounted to the interior of the chassis 27. A second cam arm 22 is hingedly connected between the second cam follower 20 and a tilt rod 38, the function of which will now be described.

The second movement mechanism further comprises a first pivot ring 15a, which is pivotally mounted to the chassis 27 on supports 28. The pivot ring 15a is able to pivot on the supports about an axis (C in FIG. 8) perpendicular to the axis B. The axis C passes through the articulation point of the universal joint 8. A second pivot ring 18a is pivotally mounted within the first pivot ring 15a for pivoting about the axis B. Thus, the first and second pivot rings 15a, 18a effectively form a gimbal. The second pivot ring 18a defines an aperture through which the end of the universal joint 8 attached to the axial support 3 passes, such that the universal joint 8 can rotate within this aperture about the longitudinal axis A. The axial support 3 is rotatably supported by the third movement mechanism, which is attached to the second pivot ring 18a and will be described below. Thus, the second pivot ring 18a can tilt about the transverse axis B relative to the first pivot ring 15a causing tilting of the axial support 3 about the same axis. In addition, the first pivot ring 15a can tilt about the axis C relative to the chassis 27 causing tilting of the axial support 3 about the same axis. This latter movement can be used to control banking of the wing without a bulk movement of the whole device.

The tilt rod 38 of the second movement mechanism connects the second cam arm 22 to the second pivot ring 18a, such that reciprocal motion of the second cam follower 20 results in corresponding tilting of the second pivot ring 18a about the transverse axis B and consequent tilting of the axial support 3 about the same axis. The exact movement of the axial support 3 about the transverse axis B can be determined by the configuration, i.e. shape, size and position, of the first cam track 9 and the length of the second cam arm 22.

Referring now to FIGS. 8 and 10, the components of the wing movement mechanism which generate the third movement (flexure of the vanes 1, 2) will be described in detail. In this embodiment, the third movement mechanism does not comprises a circular cam member, but rather a guide bar 39 which is fixedly mounted to the second pivot ring 18a so that the axial support 3 can rotate about its axis A relative to the guide bar 39. A third cam follower 24 slidably receives the guide bar 39 in an aperture defined therethrough. Thus the third cam follower 24 is constrained to move along the guide bar 39. The third cam follower 24 is connected to each of the vane rods 4, 5 by respective vane arms 25. A connecting member 40 connects the first vane rod 4 and the axial support 3 to provide additional support to the axial support 3.

In this embodiment, the first vane 1 of the wing is fixedly mounted to the axial support for rotation therewith about the axis A. Thus, as the universal joint 8 and axial support 3 rotate, the third cam follower 24 moves along the guide bar 39 by virtue of the vane arm 25 connection between the first vane rod 4 and the third cam follower 24. The second vane 2 is hingedly connected to the axial support 3, such that, as the universal joint 8 and axial support 3 rotate, the deflection of the third cam follower 24 moves the vane arm 25 connected to the second vane rod 5 to flex the second vane 2 of the wing. The exact movement of the vane rods 4, 5 with rotation of the axial support 3 can be determined by the configuration, i.e. shape, size and position, of the guide bar 39 and the length of the t vane arms 25.

In an alternative embodiment, the second vane 2 of the wing may be fixedly mounted to the axial support for rotation therewith about the axis A and the first vane 1 may be hingedly connected to the axial support 3.

FIGS. 11 to 14 show a wing movement mechanism according to a fourth embodiment of the invention. In this embodiment, the wing is shown with only one vane 1 mounted to the axial support 3, but an additional vane 2 may be added as in the previous embodiments. Furthermore, the wing movement mechanism is configured to move the wing in only two independent movements. The mechanism for flexing the vane(s) of the wing has been omitted. This embodiment is included primarily in order to illustrate an alternative configuration of the first and second movement mechanisms.

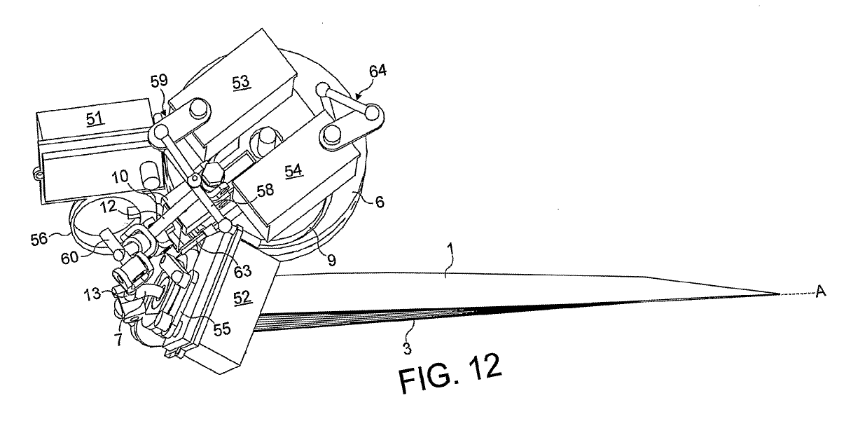

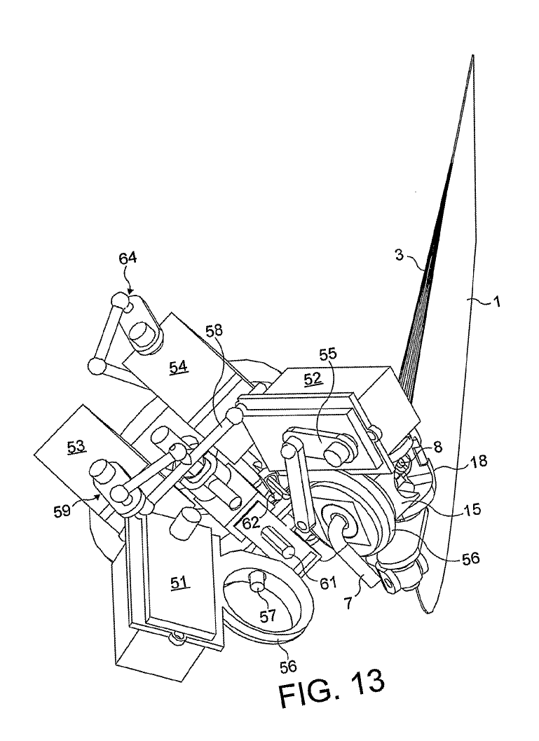

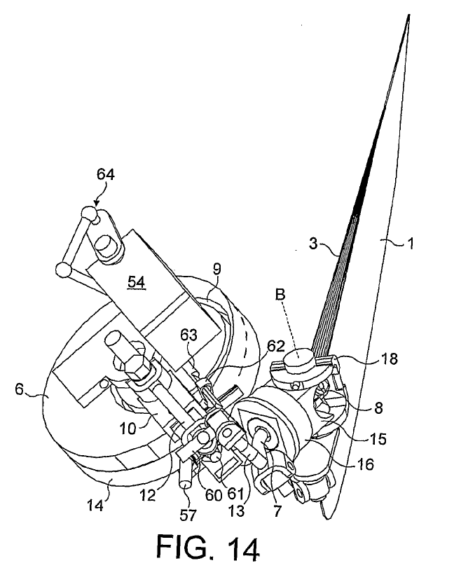

Referring now to FIGS. 12 and 14, the components of the wing movement mechanism which generate the first movement (rotation of the axial support 3 about its longitudinal axis A) will be described in detail. The first movement mechanism comprises a first drive disc 6 which is driven by an electric motor (not shown) to rotate about its centre. A first circular cam track 9 is defined as a groove in the surface of the first drive disc 6 eccentrically with respect to the drive disc 6. A first cam follower 10 engages the first cam track 9 and is constrained to linear reciprocal motion by a first cam follower guide 11 slidably received by the first cam follower 10. The first cam follower guide 11 is rotatably mounted at its end remote from the first cam follower 10 to the drive disc 6, so that the drive disc 6 can rotate with respect to the first cam follower guide 11 and the first cam follower 10. The first cam follower 10 comprises a first cam arm 12 hingedly connected thereto. A crank connector 13 is hingedly connected between the first cam arm 12 and a crank arm 7, such that reciprocal motion of the first cam follower 10 results in rotation of the crank arm 7. The crank arm 7 is mounted for rotation within an aperture in the chassis of the mechanism. The crank arm 7 passes through the aperture and is fixedly connected to a universal joint 8. The side of the universal joint 8 remote from the crank arm 7 is fixedly connected to the axial support 3 of the wing. Thus rotation of the crank arm 7 causes corresponding rotation of the universal joint 8 and hence rotation of the axial support 3 about its longitudinal axis A.

It will be seen that continuous rotation of the first drive disc 6 cause the first cam track 9 to drive the first cam follower 10 along a reciprocal path, such that the crank arm 7 and hence the axial support 3 are rotated reciprocally about their axes. The exact movement of the axial support 3 about its longitudinal axis A can be determined by the configuration, i.e. shape, size and position, of the first cam track 9.

Referring now to FIG. 11, the components of the wing movement mechanism which generate the second movement (tilting of the axial support 3 about a transverse axis B) will be described in detail. The second movement mechanism comprises a second drive disc 14 mounted in facing relation and concentrically with the first drive disc 6 for rotation therewith. It should be noted that the second drive disc 14 may be driven by a second electric motor (not shown) independently of the rate of rotation of the first drive disc 6, if desired. However, in this embodiment, the first and second drive disc 6, 14 are fixed together in operation.

A second circular cam track 19 is defined in the surface of the second drive disc 14 eccentrically with respect to the drive disc 14. A second cam follower 20 engages the second cam track 19 and is constrained to linear reciprocal motion by a second cam follower guide 21 slidably received by the second cam follower 20. The second cam follower guide 21 is rotatable mounted on the second drive disc 14, so that the second drive disc 14 can rotate with respect to the second cam follower guide 21 and the second cam follower 20. A second cam arm 22 is hingedly connected between the second cam follower 20 and a second pivot member 18, the function of which will now be described.

The second movement mechanism comprises a first pivot member 15 having a cylindrical collar 16 (shown in FIG. 14) located around the crank arm 7 and which provides the aperture in which the crank arm 7 rotates. In this way, the crank arm 7 and universal joint 8 can rotate with respect to the first pivot member 15. The first pivot member 15 extends from the collar 16 as a generally C-section yolk within which the hinged parts of the universal joint 8 are received. A second pivot member 18 is generally U-shaped and is pivotally connected to the first pivot member 15, such that the second pivot member 18 can pivot with respect to the first pivot member 15 about the transverse axis B. Between its limbs, the second pivot member 18 has an aperture defined therein for receiving the end of the universal joint 8 attached to the axial support 3, such that the universal joint 8 can rotate within this aperture about the longitudinal axis A. Tilting of the second pivot member 18 about the transverse axis B causes tilting of the axial support 3 about the same axis. As mentioned above, the second cam arm 22 is connected to the second pivot member (via an extension piece 41). Consequently, reciprocal motion of the second cam follower 20 results in tilting of the second pivot member 18 about the transverse axis B and consequent tilting of the axial support 3 about the same axis.

It will be seen that continuous rotation of the second drive disc 14 causes the second cam track 19 to drive the second cam follower 20 along a reciprocal path, such that the second pivot member 18 and hence the axial support 3 are tilted reciprocally about the transverse axis B. The exact movement of the axial support 3 about the transverse axis B can be determined by the configuration, i.e. shape, size and position, of the second cam track 19.

As shown in FIGS. 13 and 14, the wing movement mechanism of the fourth embodiment has four servos 51, 52, 53, and 54 for controlling the orientation and movement of the wing. The first servos 51, 52 control the orientation of the axis B about which the wing reciprocates with a pivoting movement. In the Figures, the first servo 51 is provided to control a wing movement mechanism for a second wing corresponding to that shown. This wing movement mechanism is not shown for reasons of clarity, but operates in a corresponding manner to the mechanism described. The first servo 52 is connected via a hinged connection 55 to the collar 16 of the first pivot member 15. As the drive pin of the first servo 52 rotates the collar 16 is rotated about its axis to rotate the first and second pivot members 15, 18 and therefore the axis B about which the axial support pivotally reciprocates.

The second servo 53 controls the orientation of the wings relative to the body of the mechanism that incorporates the drive discs 6, 14. As shown in FIGS. 12 and 13, the mechanism comprise supports rings 56 in which the collars 16 of the respective first pivot members 15 are mounted. The support rings 56 are integrally formed with the supports for the first servos 51, 52 and are mounted for pivotal movement on a forked support bar 57, as shown most clearly in FIGS. 11 and 13. The two first servos 51, 52 are connected by a cross bar 58 which is connected at its centre to the drive pin of the second servo 53 by a linkage 59 and ball joints. As drive pin of the second servo 53 is rotated, the linkage 59 pulls or pushes the cross bar 58 in a direction substantially parallel to its length. This moves the first servos 51, 52 in the same direction causing the attached support rings 56 to pivot about the ends of the forked support bar 57. The result of this movement is to raise one wing relative the body of the mechanism and to lower the other correspondingly. This achieves a banking effect of the wings.

The third servo 54 controls the relative range of angular movement of the wings about the wings shafts 3. Again, this by increasing a the range of angular movement of one wing relative to the other a steering effect can be achieved. As described above, the angular reciprocation of the wing about the axial support 3 is caused by the transmission of the reciprocating linear motion of the first cam follower 10 to the crank 7 connected to the axial support via the universal joint 8. The transmission is achieved by means of a first cam arm 12 connected to the first cam follower 10 and a crank connector 13 connected to the crank 7. However, the first cam arm 12 is connected to the crank connector 13 via a T-piece 60. The upright of the T-piece 60 passes through a collar which is hingedly mounted to the end of the first crank arm 12. The ends of the cross bar of the T-piece 60 engage in corresponding collars which are hingedly mounted to the ends of the crank connectors 13 for each wing (only one is shown in the Figures). The base of the T-piece is hingedly connected to an L-shaped angular control bar 61 which lies in a plane substantially parallel to that of the drive discs 6, 14 and is mounted in the chassis for rotation about an axis in this plane that runs along the centre of the device. The base of the T-piece 60 is mounted to the angular control bar 61 in such a manner that as the bar rotates about this axis, the cross-bar of the T-piece is moved toward one wing and away from the other. This movement has the effect of shortening the effective stroke of one of crank connectors 13 and lengthening that of the other. In this way, the range of axial movement of one wing is increased and the range of the other is decreased to provide a steering effect.

The angular control bar 61 is rotated in the manner explained above by the action of an elongate cam 62 mounted to the distal end of a rotating rod 63 which is rotated by the third servo 54 via a linkage 64. As the elongate cam 62 is rotated by the rod 63 it bears on one member of the L-shaped angular control bar 61 causing the other member to rotate about its axis. In this way, the described steering effect is controlled by the fourth servo 54.

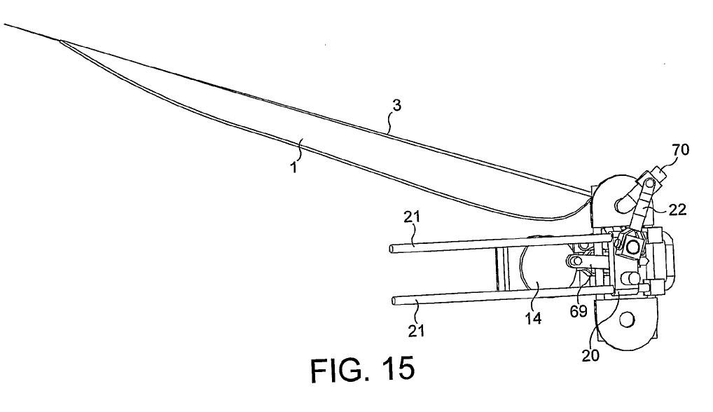

FIGS. 15 to 17 show a wing movement mechanism according to a fifth embodiment of the invention. In this embodiment, the wing is shown with only one vane 1 mounted to the axial support 3, but an additional vane 2 may be added as in the previous embodiments. Furthermore, the wing movement mechanism is configured to move the wing in only two independent movements. The mechanism for flexing the vane(s) of the wing has been omitted. This embodiment is included primarily in order to illustrate an alternative configuration of the first and second movement mechanisms. It will be appreciated from the Figures that this embodiment is configured to drive two wings, but only one wing and the associated movement mechanism is shown.

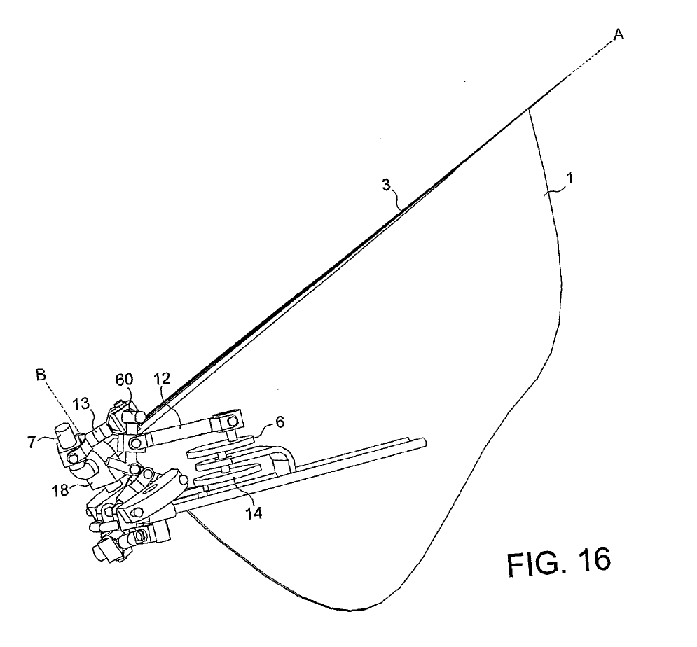

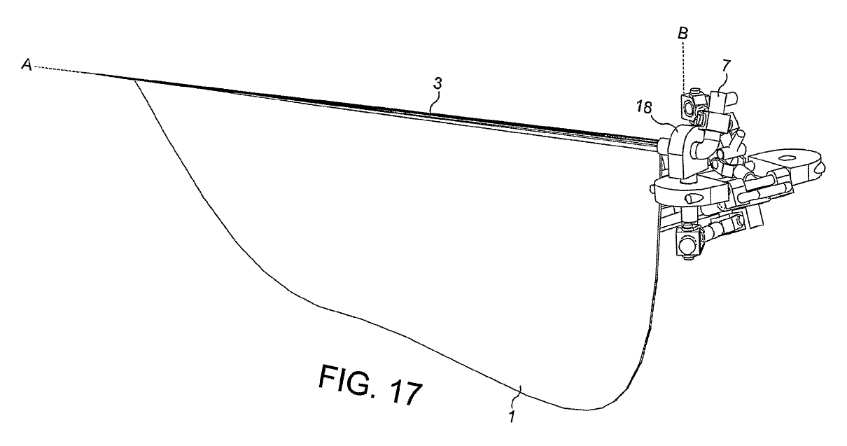

Referring now to FIGS. 16 and 17, the components of the wing movement mechanism which generate the first movement (rotation of the axial support 3 about its longitudinal axis A) will be described in detail. The first movement mechanism comprises a first drive disc 6 which is driven by an electric motor (not shown) to rotate about its centre. In this embodiment, the first cam arm 12 is driven directly by connection to a pin mounted on the surface of the first drive disc 6. A crank connector 13 is hingedly connected between the first cam arm 12 and a crank arm 7 via a T-piece 60 as described in relation to the previous embodiment. Thus, reciprocal motion of the first cam arm 12 due to rotation of the first drive disc 6 results in reciprocating rotation of the crank arm 7. The crank arm 7 is mounted for rotation within a pivot member 18. The crank arm 7 passes through the pivot member 18 and is fixedly connected to the axial support 3 of the wing. In this embodiment there is no universal joint between the crank 7 and the axial support 3 of the wing. Rotation of the crank arm 7 causes corresponding rotation of the axial support 3 about its longitudinal axis A.

Referring now to FIGS. 15 and 17, the components of the wing movement mechanism which generate the second movement (tilting of the axial support 3 about a transverse axis B) will be described in detail. The second movement mechanism comprises a second drive disc 14 mounted in facing relation and concentrically with the first drive disc 6 for rotation therewith. It should be noted that the second drive disc 14 may be driven by a second electric motor (not shown) independently of the rate of rotation of the first drive disc 6, if desired. However, in this embodiment, the first and second drive disc 6, 14 are fixed together in operation.

A slider 20 is connected to a pin attached to the surface of the second drive disc 14 by a connector 69. The slider 20 is constrained to linear reciprocal motion by slider guides 21 which are slidably received by the slider 20. A second cam arm 22 is hingedly connected between the slider 20 and a second crank 70. The second crank 70 is mounted for rotation in an aperture in the chassis of the device and at its end remote from the second cam arm 22 is fixedly connected to the pivot member 18. Consequently, reciprocal motion of the slider 20 results in reciprocating rotation of the second crank 70 and thus tilting of the pivot member 18 about the transverse axis B and consequent tilting of the axial support 3 about the same axis.

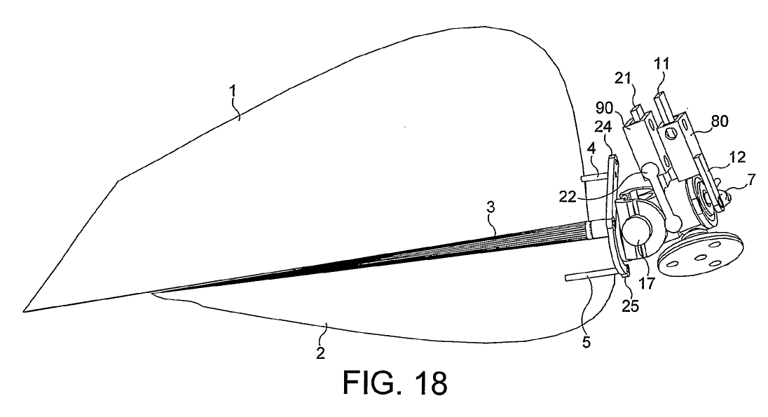

FIG. 18 shows a wing movement mechanism according to a sixth embodiment of the invention. This embodiment corresponds generally to that of FIGS. 1 to 4, but in this embodiment the drive discs 6, 14 and cam tracks 9, 19 are removed and the cam followers 10, 20 are replaced by respective linear motors 80, 90, preferably programmable linear motors. The linear motors 80, 90 are driven electromagnetically on the respective guides 11, 21 in a reciprocating motion equivalent to that of the cam followers 10, 20 in the embodiment of FIGS. 1 to 4 and perform the identical driving function to that of the cam followers 10, 20 in the previously-described embodiment. The operation of this embodiment is otherwise identical to that of FIGS. 1 to 4.

In the various embodiments described herein, a variety of mechanisms have been described to effect the required movement of the wing(s). These mechanisms and parts thereof may be used interchangeably where appropriate without departing from the scope of the invention.

In summary, a winged device has an axial support which is mounted for reciprocating rotary motion about a longitudinal axis of the support. A first wing vane is mounted to the axial support for rotation with the axial support. A second wing vane is mounted to the axial support. A cam follower is constrained to a defined movement path by a cam. A first connector connects the first wing vane to the cam follower such that the cam follower is moved along the cam by the first connector as the first wing vane moves with rotation of the axial support about its longitudinal axis. A second connector connects the second wing vane to the cam follower such that the second wing vane is moved by the second connector as the cam follower member is moved along the cam. The cam profile is defined relative to the axis of the axial support such that the relative orientation of the wing vanes changes as the axial support is rotated. The axial support is received by a pivot member within which the axial support can rotate about its longitudinal axis. The pivot member is driven in reciprocating angular motion about a transverse axis which crosses the longitudinal axis of the axial support, so that the axial support oscillates about the transverse axis.

1. A winged device comprising:
an axial support mounted for reciprocating rotary motion about a longitudinal axis of the support;
a first wing vane mounted to the axial support for rotation therewith;
a second wing vane mounted to the axial support;
a follower member constrained to a defined movement path by at least one follower guide,
a first connector which connects the first wing vane to the follower member such that the follower member is moved along the movement path by the first connector as the first wing vane moves with rotation of the axial support about its longitudinal axis;
a second connector which connects the second wing vane to the follower member such that the second wing vane is moved by the second connector as the follower member is moved along the movement path;
wherein the movement path of the follower member is defined relative to the axis of the axial support such that the relative orientation of the wing vanes changes as the axial support is rotated.

2. A winged device as claimed in claim 1, wherein the follower guide is a cam and the follower member is a cam follower.

3. A winged device as claimed in claim 2, wherein the cam is a circular cam mounted eccentrically with respect to the longitudinal axis of the axial support.

4. A winged device as claimed in claim 1, wherein the follower guide is a guide rail received by the follower member.

5. A winged device as claimed in claim 1, wherein the movement path is defined in a plane that is substantially perpendicular to the longitudinal axis of the axial support.

6. A winged device as claimed in claim 1, wherein the first and/or second wing vane is formed of flexible material and is fixed to the axial support for rotation therewith.

7. A winged device as claimed in claim 1, wherein the second wing vane is hingedly connected to the axial support.

8. A winged device as claimed in claim 1, further comprising a drive member connected to the axial support and arranged to impart the reciprocating rotational movement to the axial support, wherein the drive member is connected to the axial support by an articulated connection such that the angle between the drive shaft and the axial support can be varied.

9. A winged device as claimed in claim 8, wherein the articulated connection comprises a universal joint.

10. A winged device a claimed in claim 1, wherein the axial support is received by a pivot member within which the axial support can rotate about its longitudinal axis, wherein the pivot member is arranged to pivot about a transverse axis which crosses the longitudinal axis of the axial support, and the pivot member is arranged to be driven in reciprocating angular motion about the transverse axis, whereby the axial support oscillates about the transverse axis.

11. (canceled)
